(19) United States
(12) Patent Application Publication
(10) Pub. No.: US 2025/0091056 A1
(43) Pub. Date: Mar. 20, 2025

(54) MAGNETIC SEPARATORS FOR INCREASED RESIDENCEY OF MATERIAL FEEDS, AND METHODS OF USING THE SAME

(71) Applicants: Cláudio Henrique Teixeira Ribeiro, Ellicott City, MD (US); José Pancrácio Ribeiro, Nova Lima (BR)

(72) Inventors: Cláudio Henrique Teixeira Ribeiro, Ellicott City, MD (US); José Pancrácio Ribeiro, Nova Lima (BR)

(21) Appl. No.: 18/883,560

(22) Filed: Sep. 12, 2024

Related U.S. Application Data
(60) Provisional application No. 63/582,679, filed on Sep. 14, 2023.

(51) Int. Cl. B03C 1/03; B03C 1/034

(52) U.S. Cl. CPC B03C 1/03; B03C 1/034; B03C 2201/18

(57) ABSTRACT

Magnetic separators with variable height of the magnetic matrices, and methods of using the same for processing material feed with lower grades and/or very fines particle sizes, allowing for better performance in terms of mass and metallurgical recoveries as well as higher grade products.

### FIELD OF THE INVENTION

The present invention relates to apparatuses and methods for magnetic separation of material feeds to separate magnetic and non-magnetic particles. In particular, the present invention is inclusive of magnetic separating systems adapted to enhance the extraction of magnetic particles by providing increased residence during which material feeds are exposed to a magnetic field, and methods of operating such systems in the magnetic separation of material feeds.

### BACKGROUND OF THE INVENTION

Magnetic separator systems are well-known for separating magnetic and non-magnetic components, with the purpose of isolating the separated components for subsequent manufacturing purposes. Examples of conventional magnetic separators are described in patents U.S. Pat. No. 2,056,426 (Frantz); U.S. Pat. No. 4,235,710 (Sun); U.S. Pat. No. 3,346,116 (Jones); U.S. Pat. No. 3,830,367 (Stone) and WO2010/054847A1 (Ribeiro, et al.), the entire contents and disclosures of each of which are incorporated herein by reference.

In modern manufacturing of mass-volume production of low-priced commodities, economic viability typically requires that metal materials be produced in a range of hundreds or thousands of tons per hour, with continuous operation of the system. As mineral processing continues to evolve worldwide, there has been an increasing demand for the capture of metal materials from mineral deposits of lower grades. The ability to concentrate and recover such minerals in greater volumes is key for the economic feasibility in manufacturing modern commodities.

Conventional magnetic separators are poorly suited for recovering lower grade minerals in modern mineral processing. With lower grade deposits, it is often necessary to mill ores to liberate the desirable metals therein. However, milling reduces the target minerals to a very fine particle size, which reduces the effect of magnetic attraction forces on those particles, leading to poor performance from modern magnetic separators. Ultrafine particles, smaller than 45 μm, present a particular challenge as conventional magnetic separator systems have proven inefficient in effecting magnetic separation of such small particles due to their significantly reduced magnetic responsiveness. As a result, these ultrafine particles are regularly discarded without extraction of metal materials that would be viable for manufacturing purposes.

There thus remains a need for apparatuses and methods with improved efficiency in the extraction of metal materials, including from mineral deposits of lower grades and in particular from mineral feeds of ultrafine particle size.

### SUMMARY OF THE INVENTION

The present invention relates to apparatuses and methods for magnetic separation of a material feed to separate magnetic and non-magnetic particles. The present invention is inclusive of magnetic separating systems and methods that increase the residence time of a material feed exposure to a magnetic field, including systems with enlarged magnetic matrices having non-standard extended heights systems with reduced material feed flow rates, stacked systems that provide multiple sequential separation cycles, combinations of one or more or all of the foregoing, and methods of operating such systems in the magnetic separation of material feeds. Such magnetic separators enable processing of material feeds with lower grades and/or ultrafine particle sizes, providing improved performance in terms of mass and metallurgical recoveries as well as higher grade products.

A height adjuster component adapted for installation on a magnetic separator has a curved interface surface adapted for expanding a height of a pole-rotor interface component in a magnetic separator, an engagement surface for adapted for engaging a mating surface of a pole-rotor interface component, and a height-expanding surface along which a height of the height adjuster component is made to increase. The curved interface surface has a curvature approximately coinciding with a curvature of a pole-rotor interface component for which the height adjuster component is adapted to engage. The height-expanding surface may be a sloped surface, which may include a constant slope or an irregular slope. Engagement surfaces may include one or more fastening elements for selective engagement and disengagement of corresponding mating surfaces.

A height adjuster component in the form of a pole adjuster may have a curved interface surface with a concave curvature approximately coinciding with a concave curvature of a magnetic pole in a magnetic separator. The pole adjuster may be a supplementing pole adjuster adapted for installation on a magnetic pole in a magnetic separator for extending a height of the magnetic pole from a first relatively lesser height to a second relatively greater height, with a flat horizontal engagement surface adapted for engaging a flat outer surface of a magnetic pole. The pole adjuster may be a complimenting pole adjuster adapted for installation on a variable-shaped pole in a magnetic separator for extending a height of the magnetic pole from a first relatively lesser height to a second relatively greater second height, with a sloped engagement surface adapted for engaging a sloped outer surface of a magnetic pole. Engagement surfaces may include one or more fastening elements for selective engagement and disengagement of corresponding mating surfaces.

A height adjuster component in the form of a rotor adjuster may have a curved interface surface with a convex curvature approximately coinciding with a convex curvature of a rotor in a magnetic separator. The rotor adjuster may be a supplementing rotor adjuster adapted for installation on a rotor plate in a magnetic separator for extending a height of the rotor plate from a first relatively lesser height to a second relatively greater height, with a flat horizontal engagement surface adapted for engaging a flat outer surface of a rotor. Engagement surfaces may include one or more fastening elements for selective engagement and disengagement of corresponding mating surfaces.

In use, a pole adjuster may be installed to at least one pole arm of a pole for use in a magnetic separator for adjusting a height of the pole arm. If the pole arm has a constant first height along a length extending between a base-end and a free-end of the pole arm, then the pole adjuster installed thereon may be a supplementing pole adjuster adapted for extending a height of the free-end of the pole arm from a first relatively lesser height to a second relatively greater height, with a flat horizontal engagement surface adapted for engaging a flat outer surface of the pole arm. If the pole arm is a variable-shaped pole arm having a free-end of a first relatively lesser height and a base-end of a second relatively greater height, then the pole adjusted installed thereon may be a complimenting pole adjuster adapted for extending the height of the free-end of the pole arm from the first relatively lesser height to the second relatively greater height.

In a variable-shaped pole arm there may be provided a transition surface adapted for transitioning a height of the pole arm between the first height and the second height, and the complimenting pole adjuster is adapted for installation on the pole arm at the transition surface. The transition surface may have a first contoured surface, with the complimenting pole adjuster having a corresponding second contoured surface, with the first and second contoured surfaces adapted for mating engagement with one another. The first contoured surface of the transition surface may be a sloped surface with a constant slope, with the second contoured surface of the complimenting pole adjuster being a sloped surface with a corresponding constant slope. Engagement and transition surfaces may include one or more fastening elements for selective engagement and disengagement of corresponding mating surfaces.

In use, a rotor adjuster may be installed to a rotor plate for use in a magnetic separator. The rotor plate may have a constant first height along a length extending between an inner region and a free-end of the rotor plate, and the height adjuster component may be a supplementing rotor adjuster adapted for extending a height of the free-end of the rotor plate from the first relatively lesser height to a second relatively greater second height. The rotor adjusted may have a flat horizontal engagement surface adapted for engaging a flat outer surface of the rotor plate. Engagement surfaces may include one or more fastening elements for selective engagement and disengagement of corresponding mating surfaces.

Matrices for use in a magnetic separator may include a plurality of vertically oriented grooved plates aligned in parallel with one another, with each plate separated from one another by a gap that extends entirely vertically through the matrix. The plates in a matrix may have a vertical height (H) greater than 220 mm, including plates with heights in a range of 220 mm<H≤880 mm; 220 mm<H≤330 mm; 330 mm<H≤440 mm; 440 mm<H≤550 mm; 660 mm<H≤770 mm; or 770 mm<H≤880 mm.

A material feed may be subjected to magnetic separation of the particles therein by introducing the material feed to a magnetic separator and passing the material feed through a magnetic field in a matrix of the magnetic separator, where the matrix has a vertical height (H) greater than 220 mm, including plates with heights in a range of 220 mm<H≤880 mm; 220 mm<H≤330 mm; 330 mm<H≤440 mm; 440 mm<H≤550 mm; 660 mm<H≤770 mm; or 770 mm<H≤880 mm. The material feed may have a particle distribution in which P₈₀=30 μm and/or P₄₀=10 μm.

Stacked magnetic separators may include a first separation unit comprising a rotor with a plurality of matrices around a circumference thereof, a number of slurry inlets for introducing a first slurry feed to the matrices, and a number of magnetic poles for generating a magnetic field through the matrices; and a second separation unit comprising a rotor with a plurality of matrices around a circumference thereof, a number of slurry inlets for introducing a second slurry feed to the matrices, and a number of magnetic poles for generating a magnetic field through the matrices; with the magnetic separator configured to feed a particle yield from a magnetic separation cycle performed at the first separation unit as the second slurry feed to the slurry inlets of the second separation unit. The magnetic first slurry feed may be fed to the slurry inlets of the first separation unit at a first feed rate and the second slurry feed may be fed to the slurry inlets of the second separation unit at a second feed rate, the first feed rate being greater than the second feed rate. The first separation unit may be configured to extract a target particle yield of a first grade and the second separation unit may be configured to extract a target particle yield of a second grade, the first and second grades being different from one another.

### BRIEF DESCRIPTION OF THE DRAWINGS

Further features and advantages of the invention can be ascertained from the following detailed description that is provided in connection with the drawings described herebelow:

FIG. 1 shows a conventional two-pole magnetic separator with two vertically stacked rotors.

FIG. 2 shows a top-down cross-sectional view of the magnetic separator of FIG. 1, providing a top plan view of a rotor therein.

FIG. 3 shows a rotor, with a close-up view of magnetic matrices therein, as used in conventional magnetic separators.

FIG. 4 shows a conventional six-pole magnetic separator, with two vertically stacked rotors.

FIG. 5 shows the magnetic separator of FIG. 4 with omission of two top beams to facilitate viewing of a pole-rotor interface.

FIG. 6 shows a perspective view of a magnetic pole set from the magnetic separator of FIG. 4 in isolation.

FIG. 7 shows a side elevation view of the magnetic pole set of FIG. 6.

FIG. 8 shows a perspective view of two stacked rotors from the magnetic separator of FIG. 4 in isolation.

FIG. 9 shows one example of a six-pole magnetic separator according to the present invention.

FIG. 10 shows the magnetic separator of FIG. 9 with omission of two top beams to facilitate viewing of a pole-rotor interface.

FIG. 11 shows a perspective view of a magnetic pole set from the magnetic separator of FIG. 9 in isolation with supplementing pole adjusters installed.

FIG. 12 shows a side elevation view of the magnetic pole set of FIG. 11.

FIG. 13A shows a perspective view of two stacked rotors from the magnetic separator of FIG. 9 in isolation with supplementing rotor adjusters and enlarged matrices installed.

FIG. 13B shows an exploded view of a rotor of FIG. 13A.

FIG. 14 shows an example of a supplementing pole adjuster from FIGS. 11-12 in isolation.

FIG. 15 shows an example of a supplementing rotor adjuster from FIGS. 13A-13B in isolation.

FIG. 16 shows another example of a six-pole magnetic separator according to the present invention.

FIG. 17 shows the magnetic separator of FIG. 16 with omission of two top beams to facilitate viewing of a pole-rotor interface.

FIG. 18 shows a perspective view of a magnetic pole set from the magnetic separator of FIG. 16 in isolation with variable-height shaped poles.

FIG. 19 shows a side elevation view of the magnetic pole set in FIG. 18.

FIG. 20 shows an alternative arrangement of the magnetic separator of FIG. 16.

FIG. 21 shows the magnetic separator of FIG. 20 with omission of two top beams to facilitate viewing of a pole-rotor interface.

FIG. 22 shows a perspective view of the magnetic pole set of FIG. 18 in isolation with the variable-height shaped poles having complementing pole adjusters installed.

FIG. 23 shows a side elevation view of the magnetic pole set of FIG. 22.

FIG. 24 shows an example of a complementing pole adjuster from FIGS. 22-23.

FIG. 25 shows a top plan view of a six-pole magnetic separator a six-pole magnetic separator according to the present invention.

FIG. 26 shows an elevation cross-sectional view of the six-pole magnetic separator from FIG. 25 as seen at line A-A.

### DETAILED DESCRIPTION OF THE INVENTION

The following disclosure discusses the present invention with reference to the examples shown in the accompanying drawings, though does not limit the invention to those examples.

The use of all examples, or exemplary language (e.g., “such as”) provided herein is intended merely to better illuminate the invention and does not pose a limitation on the scope of the invention unless otherwise claimed. No language in the specification should be construed as indicating any non-claimed element as essential or otherwise critical to the practice of the invention, unless otherwise made clear in context.

As used herein, the singular forms “a,” “an,” and “the” include plural referents unless the context clearly dictates otherwise. Unless indicated otherwise by context, the term “or” is to be understood as an inclusive “or.” Terms such as “first”, “second”, “third”, etc. when used to describe multiple devices or elements, are so used only to convey the relative actions, positioning and/or functions of the separate devices, and do not necessitate either a specific order for such devices or elements, or any specific quantity or ranking of such devices or elements.

The word “substantially”, as used herein with respect to any property or circumstance, refers to a degree of deviation that is sufficiently small to not appreciably detract from the identified property or circumstance. The exact degree of deviation allowable in each circumstance will depend on the specific context, as would be understood by one having ordinary skill in the art.

Use of the terms “about” or “approximately” are intended to describe values above and/or below a stated value or range, as would be understood by one having ordinary skill in the art in the respective context. In some instances, this may encompass values in a range of approximately +/−10%; in other instances, there may be encompassed values in a range of approximately +/−5%; in yet other instances values in a range of approximately +/−2% may be encompassed; and in yet further instances, this may encompass values in a range of approximately +/−1%.

It will be understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof, unless indicated herein or otherwise clearly contradicted by context.

Recitations of a value range herein, unless indicated otherwise, serves as a shorthand for referring individually to each separate value falling within the stated range, including the endpoints of the range, each separate value within the range, and all intermediate ranges subsumed by the overall range, with each incorporated into the specification as if individually recited herein.

Unless indicated otherwise, or clearly contradicted by context, methods described herein can be performed with the individual steps executed in any suitable order, including: the precise order disclosed, without any intermediate steps or with one or more further steps interposed between the disclosed steps; with the disclosed steps performed in an order other than the exact order disclosed; with one or more steps performed simultaneously; and with one or more disclosed steps omitted.

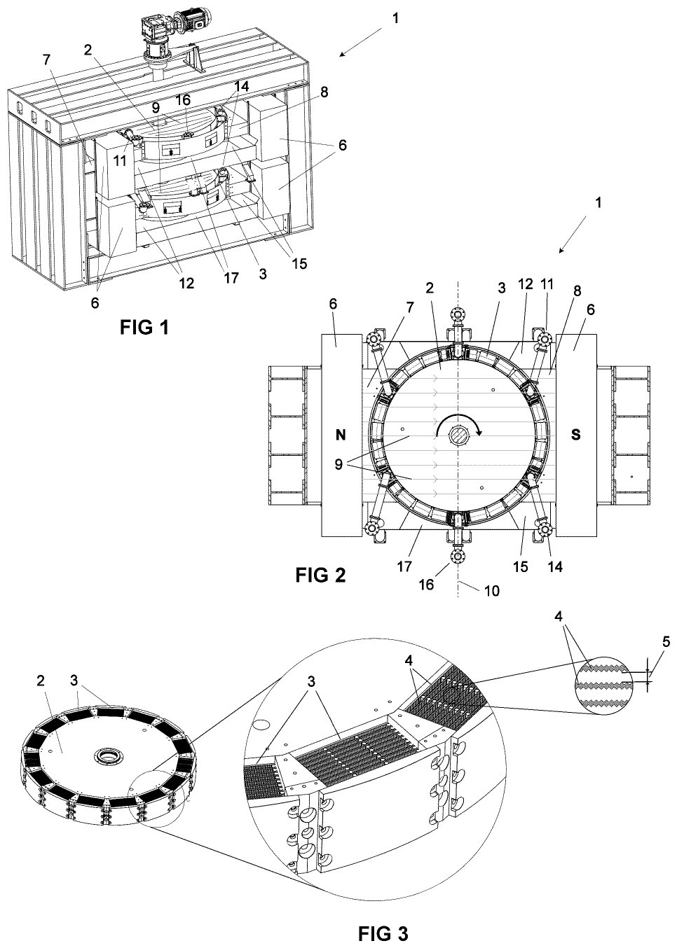

FIGS. 1-3 illustrate a conventional two-pole magnetic separator 1, such as that disclosed in U.S. Pat. No. 3,830,367 (Stone), which is operable to separate magnetic and non-magnetic components in a wet process. System 1 has a housing in which there is provided a stacked arrangement of two steel rotors 2, each in the form of a heavy disc surrounded by a series of magnetic matrices 3. Each individual magnetic matrix 3 is formed with a plurality of grooved plates 4, with each plate 4 separated from one another by a gap 5 that extends entirely vertically through the matrix 3. FIG. 3 shows one example of a rotor 2 in which a plurality of magnetic matrices 3 are arranged around a circumference of a rotor 2, with each matrix 3 comprising a plurality of grooved plates 4 and gaps 5.

As seen in FIGS. 1-2, a pair of diametrically opposed heavy steel pieces 7/8 are provided with electromagnetic coils 6 to form a north magnetic pole 7 and a south magnetic pole 8 positioned adjacent to and at opposing sides of the rotor 2. With this arrangement there is formed a strong magnetic field 9 between the opposing north and south poles 7/8, with the magnetic field 9 extending through the rotor 2, including the gaps 5 of the matrices 3 where magnetic separation takes place. The poles 7/8, the rotor 2, and the matrices 3 are each of approximately equal height to one another.

In operation, rotor 2 is rotated in a clockwise direction so that each matrix 3 passes under a slurry inlet 11 positioned proximate a leading edge of the south magnetic pole 8. As each matrix 3 passes under slurry inlet 11, a slurry is fed from inlet 11 into an upper end of the matrix 3, and through gaps 5 between grooved plates 4 thereof. The slurry is a semi-liquid mixture comprising magnetic and non-magnetic particles suspended in a liquid medium. Owing to the strong magnetic field 9, magnetic particles in the slurry immediately adhere to ridges along the surfaces of the grooved plates 4, while non-magnetic particles pass through the gaps 5 and fall out a lower end of the matrix 3, into a collecting launder 12 positioned beneath the rotor 2, for separate collection as non-magnetic product.

As the rotor 2 continues to rotate clockwise, after passing under the slurry inlet 11, each matrix 3 subsequently passes under a low-pressure flushing inlet 14 positioned proximate a trailing edge of the south magnetic pole 8. As each matrix 3 passes under the low-pressure flushing inlet 14, a low-pressure flushing liquid is fed from the inlet 14 into the upper end of the matrix 3, and through gaps 5 between grooved plates 4 thereof. Introduction of the low-pressure flushing liquid removes non-magnetic particles that were trapped in the matrix 3 by magnetic particles that adhered to the surfaces of the grooved plates 4. The low-pressure flushing liquid and non-magnetic particles removed thereby flow through the gaps 5, falling out the lower end of the matrix 3, into a collecting launder 15 positioned beneath the rotor 2, for separate collection as middling product.

As the rotor 2 continues to rotate clockwise, after passing under the low-pressure flushing inlet 14, each matrix 3 subsequently passes under a high-pressure flushing inlet 16 positioned approximately along a neutral line 10 that is equidistant between the north and south magnetic poles 7/8. The neutral line 10 represents a region with substantially zero magnet field. As each matrix 3 passes under the high-pressure flushing inlet 16, a high-pressure flushing liquid is fed from the inlet 16 into the upper end of the matrix 3, and through gaps 5 between grooved plates 4 thereof. Delivery of this high-pressure liquid removes the magnetic particles from the now demagnetized grooved plates 4, with the high-pressure flushing liquid and magnetic particles removed thereby flowing through the gaps 5, falling out the lower end of the matrix 3, into a collecting launder 17 positioned beneath the rotor 2, for separate collection as magnetic product.

As the rotor 2 continues to rotate clockwise, after passing under the high-pressure flushing inlet 16, the foregoing process described relative to the south magnetic pole 8 is then repeated at the north magnetic pole 7, with a slurry inlet positioned at a leading edge of the north magnetic pole 7, a low-pressure flushing inlet positioned at a trailing edge of the north magnetic pole 7, and a high-pressure flushing inlet positioned approximately along an opposite end of the neutral line 10. With this arrangement, system 1 is adapted so that each matrix 3 may be used to complete two separation cycles over the course of each full revolution of rotor 2. The system 1 may comprise two or more stacked arrangements of rotors 2 and poles 7/8. In stacked systems, vertically adjacent rotor and pole arrangements may be made with the north/south poles 7/8 oppositely positioned, and with each rotor 2 made to rotate in an opposite direction relative to the immediately vertically adjacent rotor(s) 2.

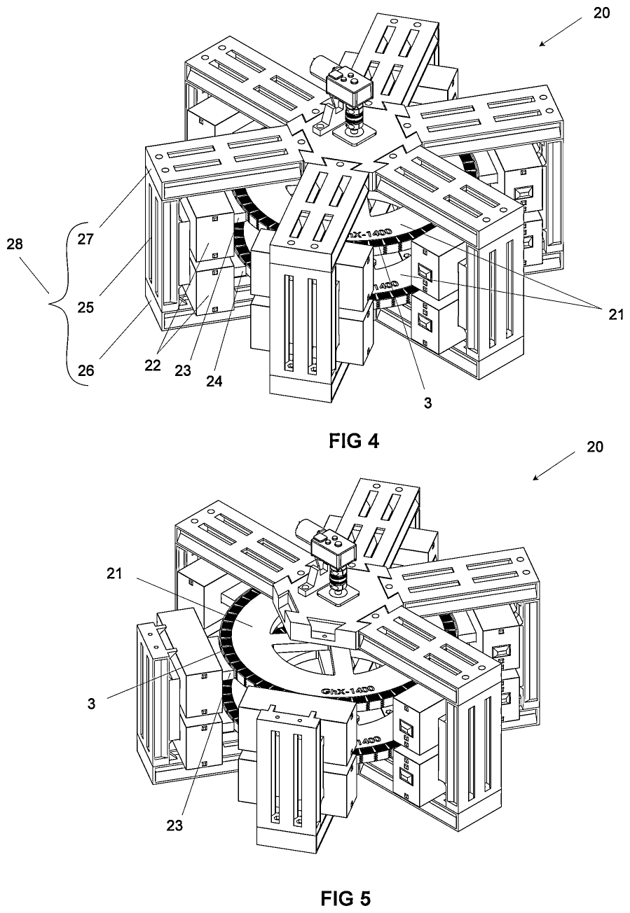

FIG. 4 illustrates a conventional six-pole magnetic separator 20 that is adapted similarly to the conventional two-pole magnetic separator 1, with the exception that there is provided a greater number of magnetic pole sets. In this example, magnetic separator 20 is provided with two vertically stacked rotors 21 that are each surrounded by a series of magnetic matrices 3. Six pole sets 28 are arranged circularly around the rotors 21, with each pole set 28 having a bottom beam 26, a vertical beam 25, and a top beam 27. The vertical beam 25 supports a top pole 23 in a position for adjacent alignment with an outer edge of the top rotor 21 and a bottom pole 24 in a position for adjacent alignment with an outer edge of the bottom rotor 21, with electromagnetic coils 22 mounted at base ends of the poles 23/24. Magnetic separator 20 operates in a similar fashion as described previously for magnetic separator 1. FIG. 5 illustrates magnetic separator 20 with omission of two top beams 27 to facilitate viewing of a pole-rotor interface between a top pole 23 and matrices 3 of the top rotor 21. The poles 23/24, rotors 21, and matrices 3 are each of approximately equal height to one another.

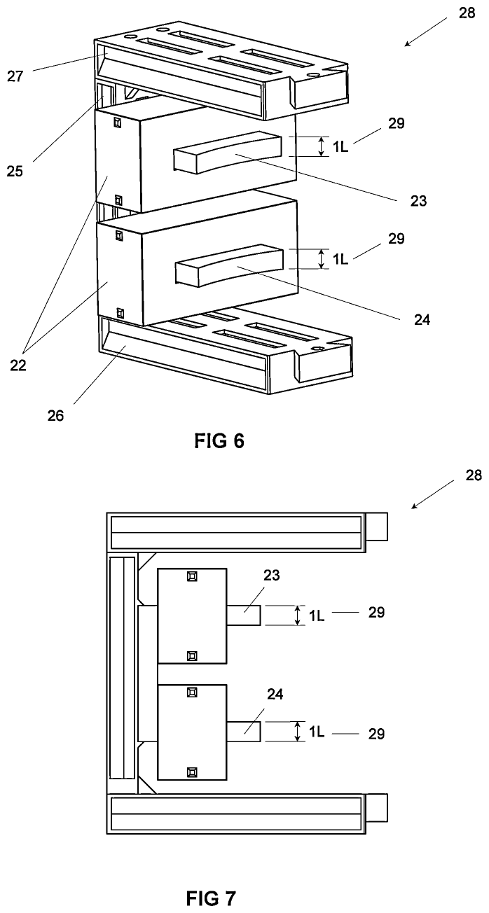

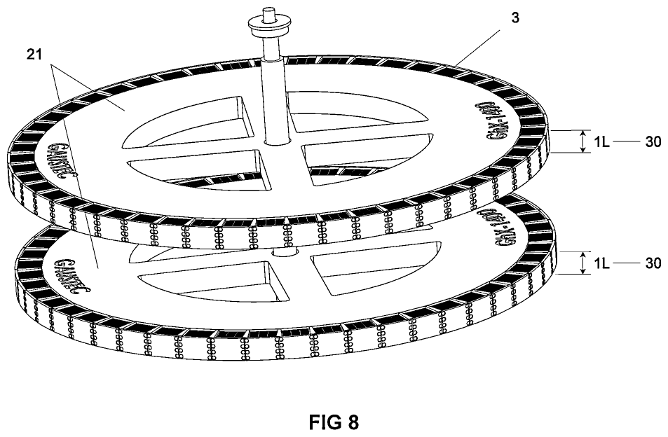

FIGS. 6 and 7 show a magnetic pole set 28 with poles 23/24 supported by vertical beam 25 and electromagnetic coils 22 mounted on poles 23/24. Poles 23/24 each have a common height 29 represented by a measurement 1 L. FIG. 8 shows top and bottom rotors 21, each with a series of matrices 3 arranged around the outer circumference thereof. Each rotor 21, and each matrix 3 provided thereto, has a common height 30 represented by a measurement 1 L, corresponding with the height 29 of poles 23/24.

While not being bound by theory, it is believed that constructing a magnetic separator 20 with poles 23/24 having free-ends (i.e., pole-rotor interfacing ends) with a height (e.g., 1 L) that is equal to a height of the matrices 3 on the rotor 21 will result in the poles 23/24 thereby generating a uniformly dispersed magnetic field within the matrices 3.

The present invention is inclusive of systems that provide an extended residence time during which a material feed is exposed to a magnetic field for effecting magnetic separation of particles within the material feed. Systems according to the present invention may enable such an extended residence of material feeds in multiple different ways. In some examples the inventive systems may use enlarged magnetic matrices of non-standard extended height that extend a residence time of a material feed by effectively extending the length of the magnetic field through which the material feed must travel. These systems with enlarged magnetic matrices further include enlarged magnetic poles and rotors for use with the enlarged matrices. Systems using enlarged matrices may be provided with height-adjustable matrices and poles, thereby enabling adjustment of the separator system based on the intended use thereof.

In some examples the inventive systems may use a reduced feed rate for a material feed to slow the passage of the material feed through a magnetic field, effectively extending the residence time of the material feed in magnetic field. In some examples, the inventive systems may include multiple stacked separation units that perform multiple sequential separation processes on a material feed, such that a single material feed is exposed to multiple magnetic fields, effectively yielding a cumulative extended residence time of the material feed across the multiple magnetic fields. The present invention is further inclusive of methods of magnetic separation, including methods of magnetically separating material feeds comprising materials of ultrafine particle sizes using magnetic separators according to the present invention.

In inventive systems using extended height poles and rotors, height-adjustment of the poles and rotors is achieved through use of adjuster components, including pole adjusters and rotor adjusters, that provide extended height to the interface surfaces of the poles and rotors, respectively. There may be at least two different types of adjuster components, namely: supplementing adjusters and complementing adjusters. Supplementing adjusters are adapted for attachment to conventional separator components (e.g., conventional poles and rotors) of standard height (e.g., 1 L) for enlarging interface surfaces of those conventional components to have a non-standard extended height (e.g., 2 L). Supplementing adjustors are especially useful for retrofitting existing magnetic separator systems for use with enlarged magnetic matrices. Complementing adjusters are adapted for attachment to variable-height shaped separator components (e.g., variable-height shaped poles and rotors) that are adapted in advance for reception of the complementing adjusters for selectively adjusting the height of the separator components between a standard height (e.g., 1 L) and one or more non-standard extended heights (e.g., 2 L, 3 L, 4 L, etc.). Complimenting adjustors are preferred for newer magnetic separator systems as this will enable such systems to selectively operate with magnetic matrices of different sizes as needed.

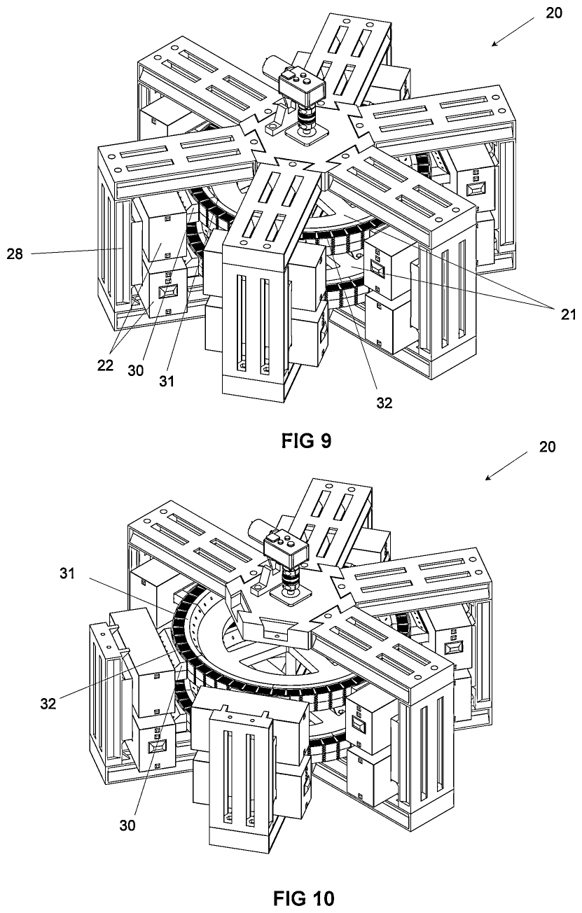

FIGS. 9-10 show one example of a six-pole magnetic separator 20 according to the present invention. FIG. 9 shows a perspective view of the magnetic separator 20 in its entirety, and FIG. 10 shows a similar view of the system in FIG. 9, though with omission of top beams 27 from two magnetic pole sets 28 to facilitate viewing of a pole-rotor interface between a top pole 23 and matrices 32 of a top rotor 21. The magnetic separator 20 is similar in construction to a conventional magnetic separator with the exception that the magnetic poles 23/24 and rotors 21 are adapted for reception of enlarged matrices 32 of non-standard height. This is achieved by retrofitting the magnetic separator 20 with supplementing pole adjusters 30 and supplementing rotor adjusters 31. FIG. 14 shows an example of a supplementing pole adjuster 30 in isolation, and FIG. 15 shows an example of a supplementing rotor adjuster 31 in isolation.

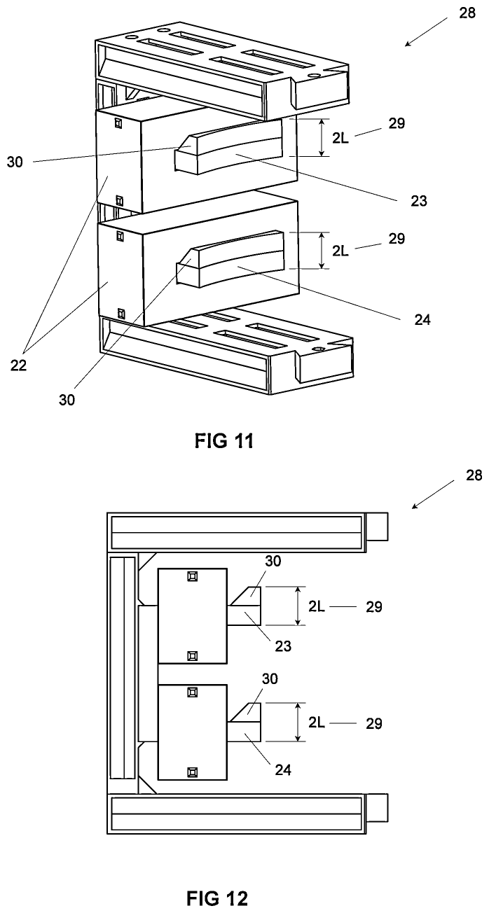

FIGS. 11-12 show a magnetic pole set 28 from the magnetic separator 20 in FIGS. 9-10 in isolation. Poles 23/24 are each adapted to have a free-end surface with a non-standard extended height 29, represented by a height measurement 2 L, that is greater than a standard height represented by a height measurement 1 L (e.g., 2 L>1 L) via installation of supplementing pole adjusters 30. With installation of the supplementing pole adjusters 30, the poles 23/24 are adapted to have a non-standard extended height 2 L corresponding with a non-standard extended height of enlarged matrices 32.

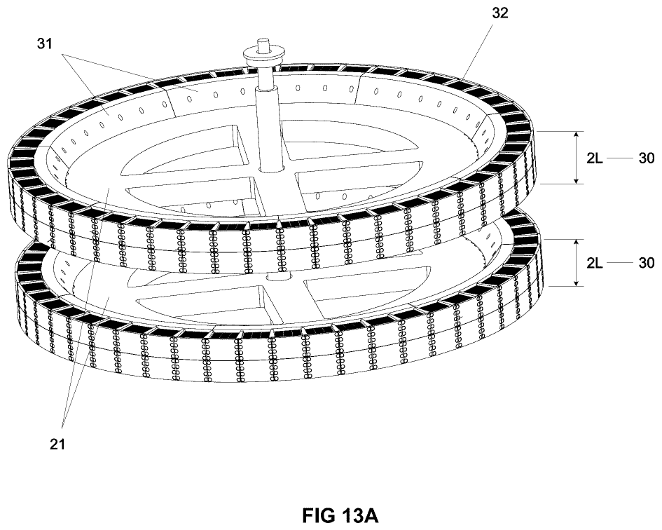

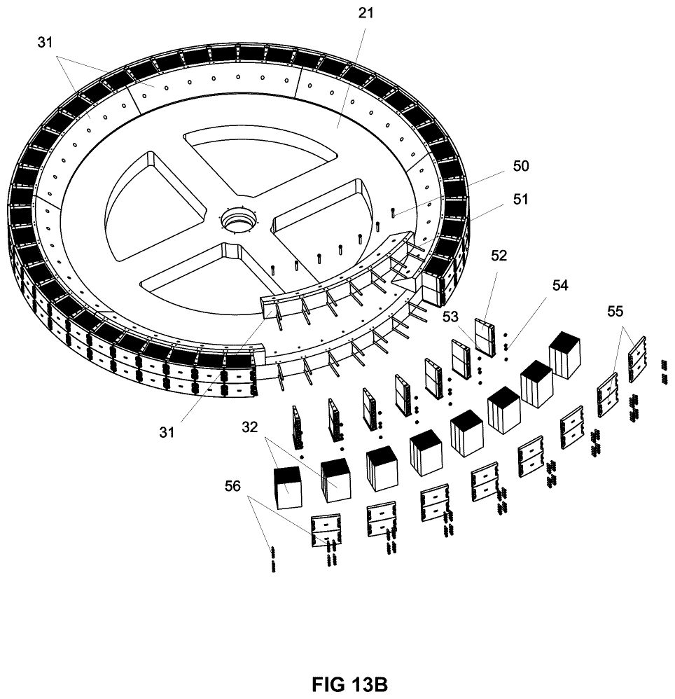

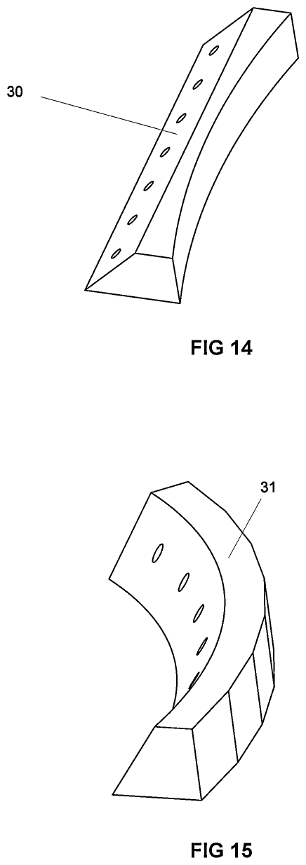

FIG. 13A shows the rotors 21 from the magnetic separator 20 in FIGS. 9-10 in isolation. The rotors 21 are each adapted to have an outer circumferential surface with a non-standard extended height 30, represented by a height measurement 2 L, that is greater than a standard height represented by a height measurement 1 L (e.g., 2 L>1 L) via installation of supplementing rotor adjusters 31. With this extended height 30, rotors 21 are adapted for securely mounting enlarged matrices 32 having a corresponding height measurement 2 L matching that of the extended height rotors 21.

FIG. 13B shows an exploded view of a rotor 21 from FIG. 13A illustrating one example of a configuration for securing supplementing rotor adjusters 31 and enlarged matrices 32 to a rotor 21. As seen in FIG. 13B, this assembly may be achieved through use of a plurality of fastening mechanisms. The supplementing rotor adjusters 31 may be secured to a top surface of a rotor 21 via a plurality of first matingly engaging fastening mechanisms. In this example, the first fastening mechanisms are illustrated as a plurality of threaded bolts 50 that are adapted to pass through vertically oriented through-holes in the supplementing rotor adjuster 31 and to matingly engage vertically oriented internally threaded blind holes in the top surface of the rotor 21. Securement of the supplementing rotor adjusters 31 to rotor 21 by the first fastening mechanisms effectively adapts rotor 21 as a vertically enlarged rotor 21 for the reception of enlarged matrices 32 having a corresponding non-standard extended height 30, represented by a height measurement 2 L.

Enlarged matrices 32 may be secured to the outer circumference of the enlarged rotor 21 via a plurality of second and third matingly engaging fastening mechanisms. In this example, the second fastening mechanisms are provided along the outer circumferences of the base rotor 21 and the supplementing rotor adjusters 31 in the form of a plurality of horizontally oriented cantilevered rods 51 that are adapted to pass through horizontally oriented through-holes in a plurality of non-magnetic wedge dividers 52 and to matingly engage internally threaded nuts 54 at an opposite side of the wedge dividers 52 to thereby secure the wedge dividers 52 along the outer circumference of the enlarged rotor 21. Securement of the wedge dividers 52 to the cantilevered rods 51 on both the base rotor 21 and a supplementing rotor adjuster 31 serves as a secondary means for securing a supplementing rotor adjuster 31 to the base rotor 21. The wedge dividers 52 are shaped as truncated cones with a relatively narrower truncated peak end abutting the outer circumference of the enlarged rotor 21 and an opposite relatively broader base end facing outwardly from the enlarged rotor 21. The wedge dividers 52 are further shaped with protruding lateral ledges at vertically oriented lower regions thereof. The lateral ledges are positioned between the narrower truncated peak and broader base end and protrude to the lateral sides of the wedge divider 52, corresponding with a circumferential direction along the enlarged rotor 21. Once the wedge dividers 52 are secured to the outer circumference of the enlarged rotor 21, enlarged matrices 32 may then be inserted between opposing pairs of wedge dividers 52 with the enlarged matrices 32 resting atop the lateral ledges of the opposing wedge dividers 52. With the enlarged matrices 32 inserted between wedge dividers 52, face plates 55 are then secured over the outer circumferences of the enlarged matrices 32 via a third fastening mechanism. In this example, the third fastening mechanisms are illustrated as a plurality of threaded bolts 56 that are adapted to pass through horizontally oriented through-holes in the face plates 55 and to matingly engage horizontally oriented internally threaded blind holes in the broader base ends of the wedge dividers 52 to secure the face plates 55 over the outer circumferential surfaces of the enlarged matrices 32, thereby fixing the enlarged matrices 32 along the circumference of the enlarged rotor 21.

The fastening mechanisms of the present invention are not limited to those illustrated in the drawings and discussed herein, and other fastening mechanisms may be used in place thereof. The wedge dividers 52 and face plates 55 may be provided either as enlarged components with heights corresponding directly to the height of the enlarged rotor 21 (e.g., a height of 2 L) or as standard components with heights corresponding directly to the height of the standard rotor 21 (e.g., a height of 1 L). When using enlarged components, a single wedge divider 52 or face plate 55 may be used to extend along the corresponding height of the enlarged rotor 21. When using standard components, two wedge dividers 52 or face plates 55 may be stacked, one atop another, so that a first of the standard components extends along a first portion of the enlarged rotor 21 (e.g., covering the base rotor 21 height) and a second of the standard components extends vertically thereabove and along a second portion of the enlarged rotor 21 (e.g., covering the supplementing rotor adjuster 31 height).

FIG. 14 shows an example of a supplementing pole adjuster 30 having a front curved interface surface that extends between a flat lower surface and a flat upper surface. A rear sloping surface at a side opposite the front curved interface surface extends between the flat lower surface and the flat upper surface with a constant slope. The interface surface is provided with a concave curvature that approximately coincides with a concave curvature of the free-ends of the poles 23/24, and which corresponds with an opposing relatively convex curvature presented by a matrix-loaded rotor 21 (e.g., a relatively circular perimeter defined by face plates 55 that reside over matrices 32). The flat lower surface is provided as a mating engagement surface for engaging a mating surface of a pole 23/24. Though FIGS. 11-12 show an example in which supplementing pole adjusters 30 are positioned with lower flat surfaces resting against upper surfaces (i.e., top surfaces) of the poles 23/24, a supplementing pole adjuster 30 may instead be positioned with the lower flat surface resting against a lower surface (i.e., bottom surface) of a pole 23/24. The flat upper surface of the supplementing pole adjuster 30 is provided as an exposed outer surface that will serve as either the uppermost surface of an expanded-height pole 23/24 (e.g., when positioned at an upper surface of the pole) or the lowermost surface of an expanded-height pole 23/24 (e.g., when positioned at a lower surface of the pole). The rear sloping surface serves as a height-expanding surface by which a height of the supplementing pole adjuster 30 is made to increase from the flat lower surface up to the flat upper surface.

FIG. 15 shows an example of a supplementing rotor adjuster 31 having a front curved interface surface that extends between a flat lower surface and a flat upper surface. A rear sloping surface at a side opposite the curved interface surface extends between the flat lower surface and the flat upper surface with a constant slope. The interface surface is made with a number of individually segmented surfaces that each have a width matching the width of a matrix 3/32. The individual segmented surfaces are flat surfaces that provide a flush mating surface for mating reception with a flat surface of a matrix 3/32, though laterally adjacent segmented surfaces are arranged at relative angles to one another such that the segmented interface surface as a whole presents a generally circular curvature. The curved segmented interface surface is provided with a convex curvature that approximately coincides with the interface surface provided by the outer circumference of the base rotor 21 itself, and which corresponds with an opposing concave curvature presented by interfacing surfaces of poles 23/24 at the pole sets 28. The flat lower surface is provided as a mating engagement surface for engaging a mating surface of a base rotor 21. The flat upper surface is provided as an exposed outer surface that will serve as either the uppermost surface of an expanded-height rotor 21 (e.g., when positioned at an upper surface of the rotor) or the lowermost surface of an expanded-height rotor 21 (e.g., when positioned at a lower surface of the rotor). The rear sloping surface serves as a height-expanding surface by which a height of the supplementing rotor adjuster 31 is made to increase from the flat lower surface up to the flat upper surface.

In the illustrated example, the magnetic separator 20 is provided with supplementing pole adjusters 30 that extend the poles 23/24 from a standard height 1 L to a non-standard extended height 2 L, and the rotors 21 are provided with supplementing rotor adjusters 31 that likewise extend the rotors 21 from a standard height 1 L to a non-standard extended height 2 L. Though the illustrated examples show the supplementing adjuster components attached to upper surfaces of the separator components (e.g., poles and rotors), the supplementing adjuster components may instead be attached to lower surfaces of the separator components. Optionally, supplementing adjuster components may be added to both the upper surface and the lower surface of one or more separator components to provide a further height increase to corresponding components (e.g., an extended height of 3 L).

When installing a supplemental adjuster component, it may also be necessary to provide expanded vertical clearance for the expanded-height components, for example, by vertically displacing the positioning of the rotors 21 to facilitate clearance of the enlarged matrices 32 relative to other surrounding components of the magnetic separator 20. In addition, upon expanding the height of the poles 23/24 there may be a corresponding reduction in a local intensity of a magnetic field generated at the enlarged matrices 32 due to a distribution of the magnetic field through the relatively greater surface areas of the enlarged matrices 32 and poles 23/24. A reduction in the local intensity of the magnetic field may be avoided by applying a higher current from the electromagnetic coils 22 along with a corresponding adjustment to the cooling systems that maintain operating temperatures of the electromagnetic coils 22, with a sufficient increase in the current to compensate for distribution of the magnetic field through the relatively greater surface areas. Advantageously, this may provide the further benefit of reducing an overall electric power consumption such that the system may be operated at a greater efficiency.

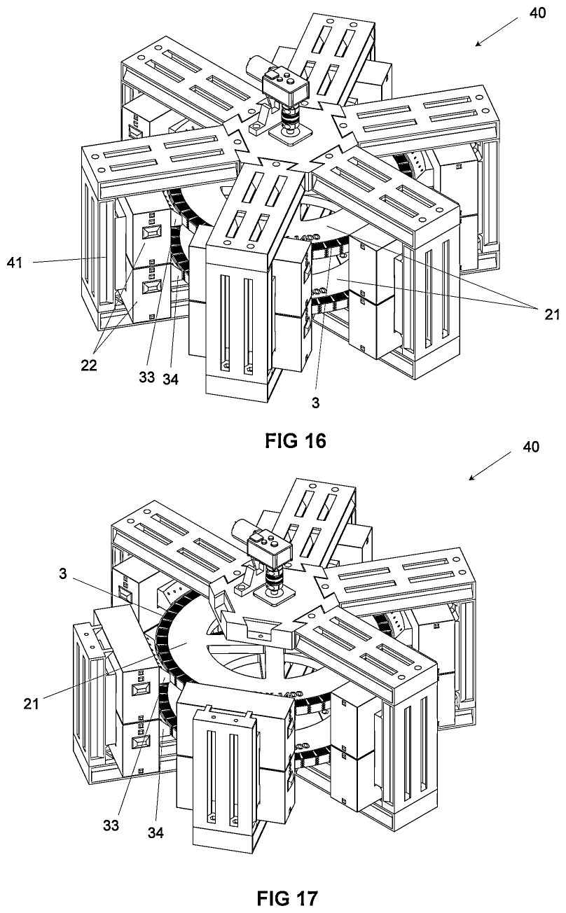

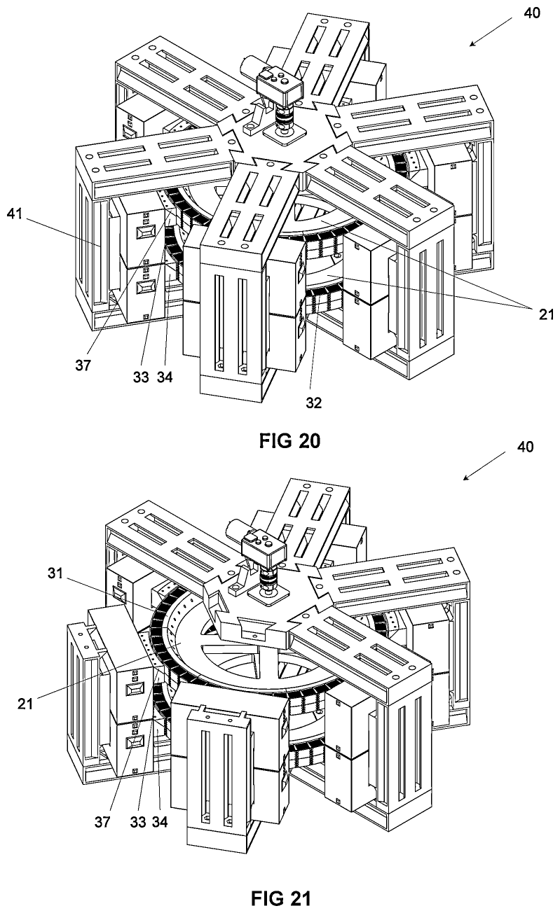

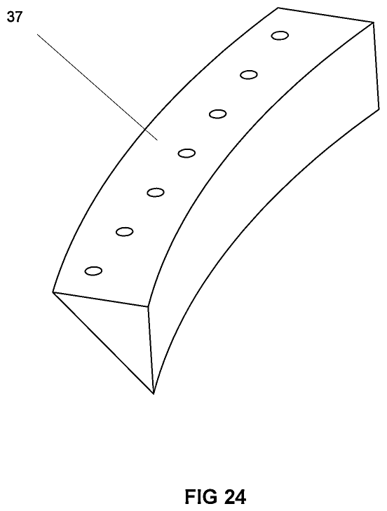

FIGS. 16-24 show another example of a magnetic separator 40 according to the present invention. FIGS. 16-19 show a first configuration in which the magnetic separator 40 is provided with variable-height shaped poles 33/34 for use with rotors 21 having standard-height matrices 3 (e.g., 1 L), with FIGS. 20-23 showing a second configuration in which the magnetic separator 40 is provided with variable-height shaped poles 33/34 with complimenting adjuster components 24 installed for use with rotors 21 having non-standard, extended height matrices 32 (e.g., 2 L), and with FIG. 24 showing an example of a complimenting pole adjuster 37 in isolation.

In these illustrated examples, the magnetic separator 40 is similar in construction to a conventional magnetic separator with the exception that the magnetic poles 33/34 are constructed with a variable-height shape adapted for selective installation of complimenting adjuster components 37 for selectively adapting the magnetic separator 40 for use with either standard-height matrices 3 (FIGS. 16-17) or non-standard, extended-height matrices 32 (FIGS. 20-21). In the illustrated examples, the variable-height shape is one in which a base-end of a pole 33/34, where the pole 33/34 is supported by the vertical beam 25, is made with a relatively greater non-standard height (e.g., 2 L) while an opposite free-end of the same pole 33/34, where the pole 33/34 interfaces with a matrix-loaded rotor 21, is made with a relatively lesser standard height (e.g., 1 L). The variable-height shape is further characterized in that, along a length of the pole 33/34, between the base-end and the free-end, there is provided a transition surface along which a height of the pole 33/34 is made to reduce from the relatively greater height of the base-end to the relatively lesser height of the free-end. In the illustrated examples, the transition surface is provided as a chamfered surface with a constant slope; however, it will be understood that the variable-height shape may take any number of forms and that the transition surface may be provided as a surface with an irregular slope or shape.

FIG. 16 shows a perspective view of the magnetic separator 40 in a first configuration, and FIG. 17 shows a similar view of the system in FIG. 16, though with omission of top beams 27 from two magnetic pole sets 41 to facilitate viewing of a pole-rotor interface between a top pole 33 and matrices 3 of a rotor 21. In this first configuration, the rotor 21 is provided with matrices 3 of standard height (e.g., 1 L) and the pole sets 41 are constructed with variable-height shaped poles 33/34 adapted for selectively setting a height of the free-ends of the poles 33/34 to either a standard height (e.g., 1 L) or a non-standard extended height (e.g., 2 L). In this first configuration, with the rotor 21 having matrices 3 of standard height (e.g., 1 L), the poles 33/34 are selectively set to a corresponding standard height (e.g., 1 L) via omission of any complimenting pole adjusters 37.

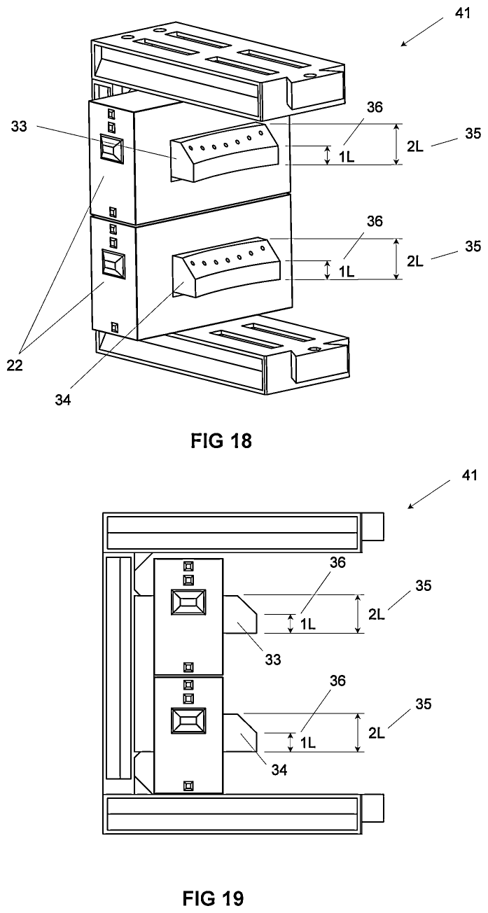

FIGS. 18-19 show a magnetic pole set 41 from the magnetic separator 40 in FIGS. 16-17 in isolation. The poles 33/34 are each provided with a variable-height shape in which base-ends of the poles 33/34 have a relatively greater non-standard height 35, represented by a height measurement of 2 L, and free-ends of the poles 33/34 have a relatively lesser standard height 36, represented by a height measurement of 1 L. A chamfered surface having a constant slope is provided as a transition surface between the relatively greater height at the base-ends of the poles 33/34 and the relatively lesser height at the free-ends of the poles 33/34. When magnetic separator 40 is operated with the rotors 21 in the configuration shown in FIGS. 16-17, with matrices 3 of a standard height (e.g., 1 L), the poles 33/34 are operated without installation of complimenting pole adjusters 37, as shown in FIGS. 18-19, such that the free-ends of the poles 33/34 have the relatively lesser height (e.g., 1 L) corresponding with the standard height matrices 3.

In this configuration the variable-height-shaped poles 33/34 will generate magnetic fields in the standard-height matrices 3 of greater intensity than that which would otherwise result from standard shaped poles. This is due to the magnetic field lines that are generated within the relatively larger height at the base-ends of the poles 33/34 being condensed into the relatively lesser height at the free-ends of the poles 33/34, resulting in a concentrated magnetic field intensity. Optionally, an increase in magnetic field intensity may be avoided by applying a lower current from the electromagnetic coils 22, along with a corresponding adjustment to the cooling systems that maintain operating temperatures of the electromagnetic coils 22, with a sufficient decrease in the current to compensate for the concentration of the magnetic field through the relatively lesser surface areas.

FIG. 20 shows a perspective view of the magnetic separator 40 in a second configuration, and FIG. 21 shows a similar view of the system in FIG. 20, though with omission of top beams 27 from two magnetic pole sets 41 to facilitate viewing of a pole-rotor interface between a top pole 33 and matrices 32 of a rotor 21. In this second configuration, the rotors 21 are provided with matrices 32 of non-standard extended height (e.g., 2 L) and the pole sets 41 are constructed with variable-height shaped poles 33/34 adapted for selectively setting a height of the free-ends of the poles 33/34 to either a standard height (e.g., 1 L) or a non-standard extended height (e.g., 2 L). In this second configuration, with the rotors 21 having matrices 32 of non-standard extended height (e.g., 2 L), the poles 33/34 are selectively set to a corresponding non-standard extended height (e.g., 2 L) via installation of complimenting pole adjusters 37.

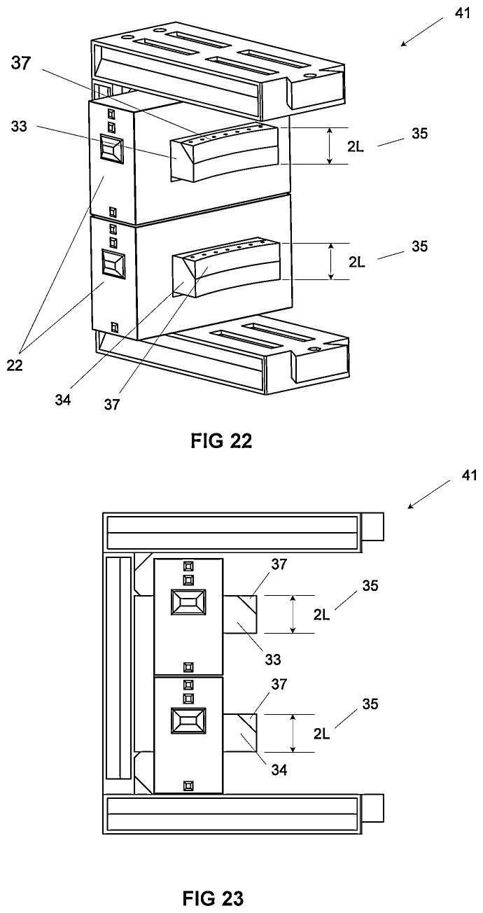

FIGS. 22-23 show a magnetic pole set 41 from the magnetic separator 40 in FIGS. 20-21 in isolation. In this example, the poles 33/34 are each provided with a variable-height shape in which base-ends of the poles 33/34 have a relatively greater height 35, represented by a height measurement of 2 L, and free-ends of the poles 33/34 formed with a relatively lesser height 36, represented by a height measurement of 1 L (see FIGS. 18-19). However, in this second configuration, the free-ends of the poles 33/34 are selectively made to have a greater extended height 35 (2 L) to correspond with the non-standard extended height of the enlarged matrices 32 at the rotors 21. This is achieved by installing complimenting pole adjusters 37 at the transition surfaces of the poles 33/34 to thereby expand the height of the free-ends of the poles 33/34 to correspond with the extended height (2 L) of the base-ends of the poles 33/34.

FIG. 24 shows an example of a complimenting pole adjuster 37 in isolation. In this example, the complimenting pole adjuster 37 has a front curved interface surface that extends between a sloped lower surface and a flat upper surface. The interface surface is provided with a concave curvature that approximately coincides with a concave curvature of the free-ends of the poles 33/34, and which corresponds with an opposing generally convex curvature presented by interfacing surfaces of a matrix-loaded rotor 21. The sloped lower surface serves as a height-expanding surface by which a height of the complimenting pole adjuster 37 is made to increase in a rear-to-front direction (i.e., base-to-interface direction). The sloped lower surface also serves as an engagement surface for engaging the complimenting pole adjuster 37 to a transition surface of a pole 33/34.

Though FIGS. 20-23 show complimenting pole adjusters 37 installed at transition surfaces at upper sides of the poles 33/34, the complimenting pole adjusters 37 may instead be installed at transition surfaces at lower sides of the poles 33/34. Though FIGS. 20-23 show an example in which a single complimenting pole adjuster 37 is installed at each pole 33/34, in other examples two complimenting pole adjusters 37 may be installed on a single pole 33/34. For example, poles 33/34 may be constructed with height-variable shapes in which base-ends of the poles 33/34 are a second non-standard height (3 L) and two transition surfaces are provided, one at an upper side of each pole 33/34 and one at a lower side of each pole 33/34, for transitioning heights of the poles 33/34 to free-ends having a standard height (1 L). In such an example, the heights of the free-ends of the poles 33/34 may be selectively adjusted from the standard height (1 L) to a first non-standard extended height (2 L) by installation of a single complimenting pole adjuster 37 via either one of the transition surfaces, or to the second non-standard extended height (3 L) by installation of two complimenting pole adjusters 37 via both transition surfaces.

The magnetic separator 40 provides additional benefits in that the heights of the poles 33/34 may be adjusted between standard heights and non-standard extended heights without need for retrofitting or otherwise modifying the system. This is due to the poles 33/34 being provided in advance with variable-height shaped poles 33/34 in which the base-ends have a maximum non-standard extended height that establishes a suitable vertical clearance for selective installation of one or more complimenting pole adjusters and one or more complimenting rotor adjusters without need to adjust vertical clearances of the system when switching between standard height and non-standard height configurations.

Though the examples in FIGS. 16-24 illustrate a variable-height shaped surface for the magnetic poles 33/34, it will be understood that the rotors 21 may likewise be made with a similar variable-height shape that is likewise selectively adjustable between standard heights (1 L) and non-standard extended heights (2 L, 3 L, etc.) via installation of one or more complimenting rotor adjusters (not shown) at one or more transition surfaces provided at the variable-height shaped rotors 21.

The local intensity of magnetic fields generated at the matrices 3/32 may vary depending on the variable-height shape provided to the poles 33/34 as well as the number of complimenting pole adjusters 37 installed thereto. For example, use of variable-height shaped poles 33/34 without complimenting pole adjusters 37 installed at each available transition surface may result in magnetic fields with relatively greater local intensity (e.g., due to concentration of magnetic field lines along the one or more vacant transition surfaces), whereas use of variable-height shaped poles 33/34 with complimenting pole adjusters 37 installed at each available transition surface will result in magnetic fields with a relatively standard local intensity (e.g., due to a constantly uniform flow of magnetic field lines through the constant height surfaces). While not being bound by theory, it is expected that in both the first and second configurations of this example, there would be no need to increase the current of the electromagnetic coils 22, and thus no need to adjust the cooling systems that maintain operating temperature of the electromagnetic coils 22. Optionally, the magnetic field intensity may be controlled by applying a corresponding adjustment to the current supplied from the electromagnetic coils 22, along with a corresponding adjustment to the cooling systems that maintain operating temperatures of the electromagnetic coils 22, with a sufficient adjustment in the current to compensate for any change to the magnetic field that would result from the chosen configuration for the variable-height shaped poles 33/34.

The adjuster components (supplementing and complementing) are adapted for installation in the magnetic separators via a mating engagement with corresponding separator components—e.g., pole adjusters being adapted for mating engagement with magnetic poles, and rotor adjusters being adapted for mating engagement with rotors. These mating engagements may include one or more mating fastening mechanisms and/or one or more correspondingly shaped mating surfaces.

The adjuster components may be adapted for installation on the separator components via one or more fastening mechanisms. One example of suitable fastening mechanisms is illustrated in the examples shown in the drawings, in which a series of through holes are formed in the adjuster components (FIGS. 13B, 14, 15, 24), a corresponding series of blind holes are formed in the separator components (FIG. 13B, 18) and positioned to align with the through-holes in the adjuster components, and a number of first and second fastener elements are provided for engagement via the through-holes and within the blind holes. In such an example, a first fastener element in the form of a threaded bolt may be adapted to extend through the through-holes in the adjuster components and into the blind holes in the separator components, with threads on outer surfaces of the threaded bolts adapted to engage mating threads on an interior surface (e.g., threaded walls) of the blind holes. Though the illustrated examples show the through-holes and blind holes oriented vertically and perpendicular to a horizontal length of the separator components, the through-holes and blind holes may instead be oriented to extend horizontally and parallel to a horizontal length of the separator components. It will be understood that fastening mechanisms are not limited to the arrangements in the illustrated examples and may instead adopt other mating configurations.

As illustrated in the examples shown in the drawings, the adjuster components are each provided with exposed surfaces that are adapted for mating with exposed surfaces on the corresponding separator components. This includes, for example, flat surfaces on some adjuster components being made to correspond with flat surfaces on some separator components (FIGS. 11-12), and sloped surfaces on some adjuster components being made to correspond with sloped surfaces on some separator components (FIGS. 22-23). It will be understood however that mating surfaces of the adjuster components and separator components are not limited to such flat and sloped surfaces and may instead adopt other mating configurations. For example, mating surfaces of the adjuster components and separator components may be provided with corresponding contoured surfaces adapted for mating engagement with one another. Examples of mating contoured surfaces include, though or not limited to corresponding irregularly sloped surfaces; one or more mating protrusions and recesses; mating elements forming a unidirectional engaging dovetail joint (e.g., a corresponding recess and protrusion adapted for sliding engagement/release in a single direction).

In conventional systems, standard matrices have a standard height of 220 mm (1 L=220 mm). The non-standard, extended height matrices discussed herein are referenced as having measurements such as 2 L, 3 L, 4 L, etc., equating to 440 mm, 660 mm, and 880 mm, respectively. However, it will be understood that non-standard, extended height matrices include matrices of any measurement greater than the standard height of 220 mm.

Non-standard, extended height matrices may have heights (H) measuring: H>220 mm; 220 mm<H≤330 mm; 220 mm<H≤440 mm; 220 mm<H≤550 mm; 220 mm<H≤660 mm; 220 mm<H≤770 mm; 220 mm<H≤880 mm; 220 mm<H≤330 mm; 330 mm<H≤440 mm; 440 mm<H≤550 mm; 660 mm<H≤770 mm; 770 mm<H≤880 mm. The foregoing ranges are to be understood as referring to the ranges and all values encompassed therein, including the endpoints of the range, each separate value within the range, and all intermediate ranges subsumed thereby.

Tests were conducted to assess the performance of magnetic separators according to the present invention. These tests were performed with two different magnetic separators, a comparative system and an inventive system, that were identical to one another in every way with the exception that the comparative system had matrices and poles with a standard height of (1 L=220 mm) and the inventive system had matrices and poles with a non-standard, extended height of (2 L=440 mm).

The tests were performed with three separately fabricated material feeds with predetermined material properties. The Sample 1 material feed was made with a 20% solids content by total weight, the Sample 2 material feed was made with a 30% solids content by total weight, and the Sample 3 material feed was made with a 40% solids content by total weight. Each of the Samples 1-3 was made with a particle distribution in which 80% of the particles were smaller than 30 μm (P₈₀=30 μm), 40% of the particles were smaller than 10 μm (P₄₀=10 μm), with the solids having an iron content of 41%.

The following Table 1 presents the parameters and results of these tests, showing that the inventive system with the non-standard, extended height matrices outperformed the comparative system with the standard height matrices in each test.

TABLE 1

| | Sample 1 | | Sample 2 | | Sample 3 | |
|---|---|---|---|---|---|---|
| | System | | | | | |
| Parameters | Comparative | Inventive | Comparative | Inventive | Comparative | Inventive |
| Particle Distribution, P₈₀ (μm) | 30 | 30 | 30 | 30 | 30 | 30 |
| Particle Distribution, P₄₀ (μm) | 10 | 10 | 10 | 10 | 10 | 10 |
| Iron Ore Content (%) | 41 | 41 | 41 | 41 | 41 | 41 |
| Matric Height (mm) | 220 | 440 | 220 | 440 | 220 | 440 |
| Matrix GAP (mm) | 0.5 | 0.5 | 0.5 | 0.5 | 0.5 | 0.5 |
| Magnetic Field (Tesla) | 1.8 | 1.8 | 1.8 | 1.8 | 1.8 | 1.8 |
| Magnetic Wash Pressure (kgf/cm²) | 6.0 | 6.0 | 6.0 | 6.0 | 6.0 | 6.0 |
| Middlings Wash Pressure (kgf/cm²) | 0 | 0 | 0 | 0 | 0 | 0 |
| Solids Content W.W. (%) | 20 | 20 | 30 | 30 | 40 | 40 |
| RPM of Rotor | 4 | 4 | 4 | 4 | 4 | 4 |
| Mass Recovery (%) | 25.96 | 39.21 | 21.64 | 40.14 | 20.00 | 48.33 |
| Iron Ore in Concentrate (%) | 57.23 | 58.54 | 53.92 | 51.42 | 45.34 | 43.34 |
| Iron Ore in Tailings (%) | 33.41 | 30.63 | 36.16 | 33.42 | 36.69 | 37.87 |

In the Sample 1 test, the comparative system extracted 25.96% of the iron ore while the inventive system extracted 39.21%, representing an approximate 51% increase in recovery from the comparative system to the inventive system. The inventive and comparative systems had similar percentages of iron ore present in the concentrate and tailings collections, with the comparative system yielding a concentrate with 57.23% iron ore and a tailings with 33.41% iron ore and the inventive system yielding a concentrate with 58.54% iron ore and a tailings with 30.63% iron ore.

In the Sample 2 test, the comparative system extracted 21.64% of the iron ore while the inventive system extracted 40.14%, representing an approximate 85.5% increase in recovery from the comparative system to the inventive system. The inventive and comparative systems again had similar percentages of iron ore present in the concentrate and tailings collections, with the comparative system yielding a concentrate with 53.92% iron ore and a tailings with 36.16% iron ore and the inventive system yielding a concentrate with 51.42% iron ore and a tailings with 33.42% iron ore.

In the Sample 3 test, the comparative system extracted 20.00% of the iron ore while the inventive system extracted 48.33%, representing an approximate 141.7% increase in recovery from the comparative system to the inventive system. The inventive and comparative systems again had similar percentages of iron ore present in the concentrate and tailings collections, with the comparative system yielding a concentrate with 45.34% iron ore and a tailings with 36.69% iron ore and the inventive system yielding a concentrate with 43.34% iron ore and a tailings with 37.87% iron ore.

These tests show that the inventive system provides significant gains in the mass recovery of iron ore from the material feed samples, representing a far superior performance in extracting magnetic particles from material feeds, including an approximately 2.5 times greater performance as seen in the Sample 3 test. The substantially similar results seen in the iron ore content of the concentrates and tailings collections of the comparative and inventive systems confirms that the greater mass recovery achieved by the inventive system is indeed representative of a greater extraction of iron particles. These results confirm that the increased height of the non-standard, extended height matrices in the inventive system enables a greater recovery of ultrafine particles that would otherwise be discarded as tailings by conventional systems.

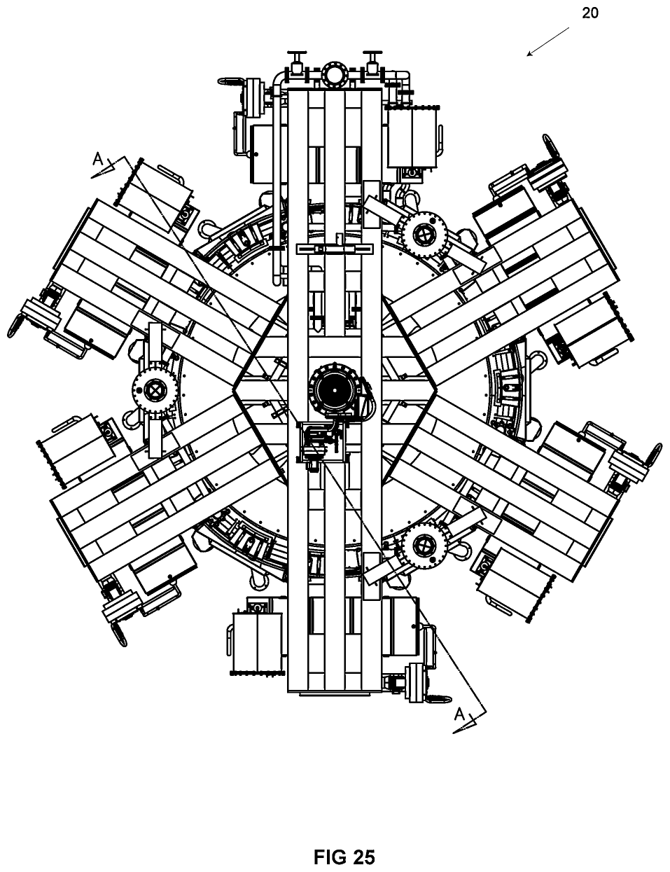

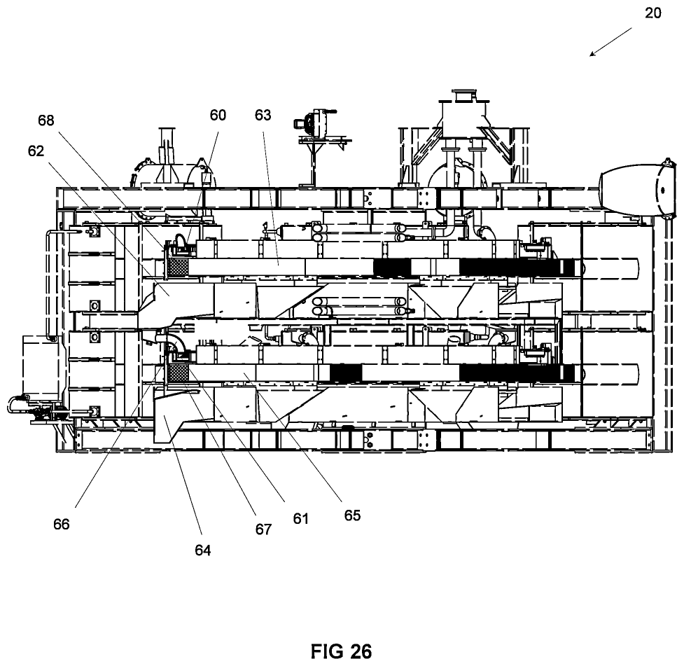

FIGS. 25-26 show an example of a two-stack, six-pole magnetic separator 20 according to the present invention. The magnetic separator 20 is configured to perform multiple sequential separation cycles for a material feed, effectively increasing residence of the material feed through a magnetic field by providing repeat exposure of the material feed to magnetic fields in multiple separation cycles.

FIG. 25 shows a top plan view of the six-pole magnetic separator 20 and FIG. 26 shows an elevation cross-sectional view of the six-pole magnetic separator 20 as seen at line A-A in FIG. 25. As seen in FIG. 26, this magnetic separator 20 has two stacked rotors 63/65 and a distributor 70 that distributes a primary material feed for magnetic separation through the two stacked rotors 63/65.

In a conventional stacked magnetic separator, a distributor receives a primary material feed and distributes that material feed to slurry inlets at each pole set for each of the stacked rotors. For example, in a conventional two-stack, six-pole magnetic separator, the distributor would distribute a primary material feed to twelve separate slurry inlets, including six slurry inlets among the six pole sets of a top rotor and six slurry inlets among the six pole sets of a bottom rotor. With this configuration, the individual rotors in the conventional stacked magnetic separator operate in parallel to perform independent magnetic separation cycles separate from one another.

In a stacked magnetic separator according to the present invention, such as that illustrated in FIGS. 25-26, a distributor receives a primary material feed and distributes that material feed as a first slurry feed only to slurry inlets among pole sets of a first rotor in the stack, and particle yields from the magnetic separation cycle performed at that first rotor are then fed as a second slurry feed to slurry inlets among pole sets of a second rotor in the stack for a secondary magnetic separation cycle. This separation process may repeat for any number of separation cycles depending on the number of stacked rotors in the stacked magnetic separator, with each subsequent rotor in the stack receiving a particle yield from a magnetic separation cycle performed by a prior rotor in the stack as a slurry feed for a further magnetic separation cycle. In this way, the stacked rotors operate in series with one another to perform sequential magnetic separation cycles on a single primary material feed.

FIG. 26 shows one example of a stacked magnetic separator 20 having a distributor 70 that receives a primary material feed which is then distributed as a first slurry feed to slurry inlets 60 for introduction to matrices 68 of a first rotor 63. The first rotor 63 performs a first magnetic separation cycle, the first slurry feed to produce a particle yield comprising non-magnetic product, middling product, and magnetic product. The magnetic product from this first magnetic separation cycle is collected in a launder (not shown) and removed as a target product while the non-magnetic product (and optionally the middling product) is collected in a re-feed launder 62. Re-feed launder 62 is provided with an outlet in fluid flow communication with a feed pipe 66 that leads to slurry inlets 61 for feeding the particle yield products from the re-feed launder 62 to the slurry inlets 61 as a second slurry feed for introduction to matrices 67 of a second rotor 65. In examples where the middling product is not collected in the re-feed launder 62 for re-feeding to the second rotor 65, the middling product is instead collected in a separate launder (not shown) for disposal. The second rotor 65 performs a second magnetic separation cycle of the second slurry feed to again produce a particle yield comprising non-magnetic product, middling product, and magnetic product. The magnetic product from this second magnetic separation cycle is collected in a launder (not shown) and removed as a target product while the non-magnetic product and middling product are collected in a launder 64 for disposal. In this way, the stacked rotors 63/65 operate in series with one another to perform first and second sequential magnetic separation cycles on a single material feed. While this example illustrates only two stacked rotors 63/65, the magnetic separator 20 may comprise any number of stacked rotors for performing any number of sequential magnetic separation cycles.

In operation, stacked magnetic separators according to the present invention may perform individual magnetic separation cycles at different flow rates. Thus, in the two-stack magnetic separator 20 illustrated in FIG. 26, the magnetic separation cycle performed at the first rotor 63 may be performed with the first slurry feed fed through the slurry inlets 60 at a first flow rate and the magnetic separation cycle performed at the second rotor 65 may be performed with the second slurry feed fed through the slurry inlets 61 at a second flow rate. For example, the first slurry feed fed through slurry inlets 60 may be pressurized via an external pump or a head pressure from an external liquid column to achieve a first relatively greater flow rate, while the second slurry feed fed through slurry inlets 61 may be subject only to a head pressure from the particle yield products collected in the re-feed launder 62 to achieve a second relatively lesser flow rate. The flow rate of the second slurry feed fed through slurry inlets 61 may be predetermined, for example, by the dimensions of the outlet of the re-feed launder 62 and/or the feed pipe 66. Optionally, a pump (not shown) may also be provided in connection with the re-feed launder 62 and/or the feed pipe 66 for pressuring the second slurry feed fed through slurry inlets 61 to enable further control over the flow rate of the second slurry feed.

The use of different flow rates for individual separation cycles within the sequential separation process may prove beneficial in ensuring greater recovery of magnetic materials. The first separation cycle performed on the first slurry feed that is fed at the first relatively greater flow rate may prove efficient for extracting a first portion of magnetic particles while failing to extract certain ultrafine magnetic particles and/or feebly magnetic particles. This may occur, for example, due to a disparity between the magnetic responsiveness of those non-extracted particles relative to hydraulic forces present in the first slurry feed that is fed at the first relatively greater flow rate. By re-feeding the particle yield from the re-feed launder of the first rotor into the second rotor for a second separation cycle, though as a second slurry feed at a second relatively lesser flow rate, there may then be a lesser disparity between the magnetic responsiveness of the previously non-extracted magnetic particles and the lesser hydraulic forces then present in the second slurry feed, thereby enabling greater success in extracting those magnetic particles that were not successfully extracted in the first separation cycle.

Without being bound by theory, it is expected that the increased success in extracting ultrafine magnetic and feebly magnetic particles in a second separation cycle may also be promoted by a relatively increased residence time of those particles within the matrices 67, due to the relatively lesser flow rate of the second slurry feed, thereby providing additional time for the magnetic field within the matrices 67 to act on the particles and overcome the hydraulic forces of the second slurry feed. This increased residence time based on the relatively lesser flow rate may have a similar effect as an increased residence time based on the use of non-standard, extended height matrices. For example, an otherwise standard separation cycle performed with a slurry feed fed through a rotor having standard height (1 L) matrices though at a reduced flow rate that is approximately 50% a standard flow rate may provide similar results as a separation cycle performed with a slurry feed fed through a rotor having non-standard, double height (2 L) matrices at a standard flow rate.

Optionally, a stacked magnetic separator 20 may be made with rotors that include extended height matrices, which may include configurations with all or only some of the stacked rotors having extended height matrices. In this way, magnetic separators according to the present invention may enable results that would otherwise be impractical from the use of extended height matrices alone. For example, a separation cycle performed with a slurry feed fed through a rotor having non-standard, double height (2 L) matrices at a reduced flow rate that is approximately 50% a standard flow rate may yield results approximately to those of a separation cycle performed with a slurry feed fed through a rotor having non-standard, quadruple height (4 L) matrices at a standard flow rate. Such configurations may be useful in instances where extraction of certain magnetic particles is expected to require an especially long residence (e.g., 4 times the standard residence) and in which it would not be practical to construct a rotor with matrices of a sufficiently large height alone to achieve the target residence time (e.g., 4 L matrices for 4× residence). Instead, a magnetic separator according to the present invention may be provided with a rotor having a combination of non-standard, extended height matrices and a reduced flow rate that together would provide the desired residence (e.g., 2 L matrices and 50% flow rate for a 4× residence).

Although the present invention is described with reference to particular embodiments, it will be understood to those skilled in the art that the foregoing disclosure addresses exemplary embodiments only; that the scope of the invention is not limited to the disclosed embodiments; and that the scope of the invention may encompass additional embodiments embracing various changes and modifications relative to the examples disclosed herein without departing from the scope of the invention as defined in the appended claims and equivalents thereto.

To the extent necessary to understand or complete the disclosure of the present invention, all publications, patents, and patent applications mentioned herein are expressly incorporated by reference herein to the same extent as though each were individually so incorporated. No license, express or implied, is granted to any patent incorporated herein.

The present invention is not limited to the exemplary embodiments illustrated herein, but is instead characterized by the appended claims, which in no way limit the scope of the disclosure.

What is claimed is:

1. A height adjuster component adapted for installation on a magnetic separator, comprising:
a curved interface surface adapted for expanding a height of a pole-rotor interface component in a magnetic separator, an engagement surface for adapted for engaging a mating surface of a pole-rotor interface component, and a height-expanding surface along which a height of the height adjuster component is made to increase,
wherein the curved interface surface has a curvature approximately coinciding with a curvature of a pole-rotor interface component for which the height adjuster component is adapted to engage.

2. The height adjuster component of claim 1, wherein
the height-expanding surface is a sloped surface.

3. The height adjuster component of claim 2, wherein
the sloped height-expanding surface has a constant slope.

4. The height adjuster component of claim 1, wherein
the height adjuster component is a pole adjuster and the curved interface surface has a concave curvature approximately coinciding with a concave curvature of a magnetic pole in a magnetic separator.

5. The height adjuster component of claim 4, wherein
the pole adjuster is a supplementing pole adjuster adapted for installation on a magnetic pole in a magnetic separator for extending a height of the magnetic pole from a first height to a second greater height.

6. The height adjuster component of claim 5, wherein
the engagement surface is a flat horizontal surface adapted for engaging a flat outer surface of a magnetic pole.

7. The height adjuster component of claim 4, wherein
the pole adjuster is a complimenting pole adjuster adapted for installation on a variable-shaped pole in a magnetic separator for extending a height of the magnetic pole from a first height to a greater second height.

8. The height adjuster component of claim 5, wherein
the engagement surface is a sloped surface adapted for engaging a sloped outer surface of a magnetic pole.

9. The height adjuster component of claim 1, wherein
the height adjuster component is a rotor adjuster and the curved interface surface has a convex curvature approximately coinciding with a convex curvature of a rotor in a magnetic separator.

10. The height adjuster component of claim 9, wherein
the rotor adjuster is a supplementing rotor adjuster adapted for installation on a rotor plate in a magnetic separator for extending a height of the rotor plate from a first height to a second greater height.

11. The height adjuster component of claim 10, wherein
the engagement surface is a flat horizontal surface adapted for engaging a flat outer surface of a rotor.

12. A pole for use in a magnetic separator, comprising:
at least one pole arm having a height adjuster component according to claim 1 installed thereon.

13. The pole according to claim 12, wherein
the pole arm has a constant first height along a length extending between a base-end and a free-end of the pole arm, and the height adjuster component is a supplementing pole adjuster adapted for extending a height of the free-end of the pole arm from the first height to a greater second height.

14. The pole according to claim 13, wherein
the engagement surface is a flat horizontal surface adapted for engaging a flat outer surface of the pole arm.

15. The pole according to claim 12, wherein
the pole arm is a variable-shaped pole arm having a free-end of a first height and a base-end of a second height, the second height being greater than the first height, and the height adjuster component is a complimenting pole adjuster adapted for extending the height of the free-end of the pole arm from the first height to the second height.

16. The pole according to claim 15, wherein
the variable-shaped pole arm comprises a transition surface adapted for transitioning a height of the pole arm between the first height and the second height, and the complimenting pole adjuster is adapted for installation on the pole arm at the transition surface.

17. The pole according to claim 16, wherein
the transition surface has a first contoured surface, the complimenting pole adjuster has a corresponding second contoured surface, and the first and second contoured surfaces are adapted for mating engagement with one another.

18. The pole according to claim 17, wherein
the first contoured surface of the transition surface is a sloped surface with a constant slope, and the second contoured surface of the complimenting pole adjuster is a sloped surface with a constant slope.

19. A rotor for use in a magnetic separator, comprising:
a rotor plate having a height adjuster component according to claim 1 installed thereon.

20. The pole according to claim 19, wherein
the rotor plate has a constant first height along a length extending between an inner region and a free-end of the rotor plate, and the height adjuster component is a supplementing rotor adjuster adapted for extending a height of the free-end of the rotor plate from the first height to a greater second height.

21. The pole according to claim 20, wherein
the engagement surface is a flat horizontal surface adapted for engaging a flat outer surface of the rotor plate.

22. A pole for use in a magnetic separator, comprising:
at least one variable-shaped pole arm having a free-end of a first height and a base-end of a second height, the second height being greater than the first height, and a transition surface adapted for transitioning a height of the pole arm between the first height and the second height, the transition surface being adapted for reception of a complimenting pole adjuster for extending the height of the free-end of the polar arm from the first height to the second height.

23. The pole according to claim 22, wherein
the transition surface has a first contoured surface adapted for mating engagement with a corresponding second contoured surface on a complimenting pole adjuster.

24. The pole according to claim 23, wherein
the first contoured surface of the transition surface is a sloped surface with a constant slope adapted for mating engagement with a second contoured surface of a complimenting pole adjuster having a sloped surface with a corresponding constant slope.

25. The pole according to claim 23, wherein
the transition surface comprises one or more fastening elements for selective engagement and disengagement of a complimenting pole adjuster.

26. A matrix for use in a magnetic separator, comprising:
a plurality of vertically oriented grooved plates aligned in parallel with one another, with each plate separated from one another by a gap that extends entirely vertically through the matrix,
wherein the plates have a vertical height (H) greater than 220 mm.

27. The matrix according to claim 26, wherein:
the plates have a vertical height (H) of 220 mm<H≤880 mm.

28. The matrix according to claim 26, wherein:
the plates have a vertical height (H) of: 220 mm<H≤330 mm; 330 mm<H≤440 mm; 440 mm<H≤550 mm; 660 mm<H≤770 mm; or 770 mm<H≤880 mm.

29. A magnetic separator comprising matrices according to claim 26.

30. A method of magnetically separating particles in a material feed, comprising:
introducing a material feed to a magnetic separator; and
passing the material feed through a magnetic field in a matrix of the magnetic separator,
wherein the matrix is one according to claim 26.

31. The method according to claim 30, wherein
the material feed has a particle distribution in which P₈₀=30 μm.

32. The method according to claim 30, wherein
the material feed has a particle distribution in which P₄₀=10 μm.

33. A magnetic separator, comprising:
a first separation unit comprising a rotor with a plurality of matrices around a circumference thereof, a number of slurry inlets for introducing a first slurry feed to the matrices, and a number of magnetic poles for generating a magnetic field through the matrices;
a second separation unit comprising a rotor with a plurality of matrices around a circumference thereof, a number of slurry inlets for introducing a second slurry feed to the matrices, and a number of magnetic poles for generating a magnetic field through the matrices;
wherein the magnetic separator is configured to feed a particle yield from a magnetic separation cycle performed at the first separation unit as the second slurry feed to the slurry inlets of the second separation unit.

34. A magnetic separator according to claim 33, wherein
the magnetic separator is configured to feed the first slurry feed to the slurry inlets of the first separation unit at a first feed rate and to feed the second slurry feed to the slurry inlets of the second separation unit at a second feed rate, the first feed rate being greater than the second feed rate.

35. A magnetic separator according to claim 33, wherein
the first separation unit is configured to extract a target particle yield of a first grade and the second separation unit is configured to extract a target particle yield of a second grade, the first and second grades being different from one another.
